(19) United States
(12) Patent Application Publication
(10) Pub. No.: US 2003/0111060 A1
(43) Pub. Date: Jun. 19, 2003

(54) Fuel supply apparatus

(76) Inventors: Daisuke Ito, Obu-shi (JP); Kazumi Haruta, Obu-shi (JP)

Correspondence Address: STEVENS, DAVIS, MILLER & MOSHER, L.L.P., Suite 850, 1615 L Street, N.W., Washington, DC, 20036, US

(21) Appl. No.: 10/320,468

(22) Filed: Dec. 17, 2002

(30) Foreign Application Priority Data
Dec. 18, 2001 (JP) 2001-402841

(51) Int. Cl. F02M 37/04; B01D 24/00

(52) U.S. Cl. 123/509; 210/416.4

(57) ABSTRACT

In a fuel supply apparatus in which a drawing performance of drawing a fuel to a reservoir cup is not dropped down even at a time when a fuel residual amount is small and a vehicle is inclined, a filter formed of a mesh woven fabric is provided in a suction port of a jet pump via the suction pipe, and at least a part of the filter extends up to at least one end portion along a bottom surface of a fuel tank, a drawing performance of drawing the fuel into the reservoir cup obtained by the jet pump does not come down, and the fuel supply to the engine is not short, even in the case that the fuel residual amount is small and the vehicle is inclined.

### BACKGROUND OF THE INVENTION

1. Field of the Invention

The present invention relates to a fuel supply apparatus having a reservoir cup arranged within a fuel tank of a motor vehicle, and more particularly to a fuel supply apparatus which can improve a drawing performance of a jet pump at a time when a fuel residual amount is small and a fuel liquid surface is inclined.

2. Description of the Related Art

As shown in FIG. 4, a fuel supply apparatus in which a fuel pump 105 is received in a reservoir cup 104 placed within a fuel tank 101, and a fuel fed into an inner side of the reservoir cup 104 from an inner side of the fuel tank 101 by a jet pump (an assist jet mechanism) utilizing a flow speed of a return fuel from a regulator is supplied to an engine by the fuel pump 105, is disclosed in JP-A-11-125163 and JP-A-2-173352. The former publication discloses that, as shown in FIG. 5, since there is provided with a nozzle mounting hole 191a open to an outer portion of the reservoir cup 104, a discharge port 191b open to an inner portion of the reservoir cup 104, a hollow oil feeding passage 107 extending in a horizontal direction from the nozzle mounting hole 191a and running up to the discharge port, and a suction port 191d open to the outer portion of the reservoir tank 104 and communicating with the oil feeding passage 107, it is possible to make an ejector (an assist jet mechanism) 109 achieve a sufficient eject effect, and it is possible to provide an inexpensive reservoir cup accompanying no complicated operation.

However, in the structure mentioned above, when the fuel residual amount is small and the vehicle is inclined, the suction port 191d comes out of the fuel liquid surface, so that there is a risk that the fuel within the reservoir cup 104 is turned back within the fuel tank 101 and the drawing amount of the fuel into the reservoir cup 104 by the jet pump is reduced, whereby the fuel supply to the engine may be short. Accordingly, an object of the present invention is to provide a fuel supply apparatus structured such that a drawing performance of drawing the fuel to the reservoir cup is not dropped down even at a time when a fuel residual amount is small and a vehicle is inclined.

### SUMMARY OF THE INVENTION

In accordance with the present invention which is made for the purpose of achieving the object mentioned above, there is provided a fuel supply apparatus comprising:

a reservoir cup placed within a fuel tank;

a fuel pump provided within the reservoir cup and supplying a fuel within the reservoir cup to an engine; and

a jet pump for pressure feeding the fuel within the fuel tank into the reservoir cup by utilizing a flow speed of the returning fuel in the fuel supplied from the fuel pump,

wherein a filter is provided in a suction port of the jet pump via a suction pipe, the filter is constituted of a mesh woven fabric, and at least a part of the filter extends at least to one end portion along a bottom surface of the fuel tank.

With the above structure, since the filter is constituted of the mesh woven fabric, the fuel is always filled in a micro fiber in the woven fabric on the basis of a capillary phenomenon. Accordingly, even when the fuel residual amount is small and the vehicle is inclined, so that a part of the filter comes out of the fuel liquid surface, an inflow of air from the filter come out of the fuel liquid surface is few owing to a surface tension of the fuel filled in the filter, and it is possible to suck the fuel from the filter portion which is dipped into the fuel. Therefore, it is possible to maintain the fuel drawing performance of the jet pump by structuring such that a part of the filter is always dipped into the fuel even when the vehicle is inclined in any directions.

### BRIEF DESCRIPTION OF THE DRAWINGS

FIG. 1 is a conceptual view of a fuel supply apparatus in accordance with a first embodiment of the present invention;

FIG. 2 is a conceptual view of a fuel supply apparatus in accordance with a second embodiment of the present invention;

FIG. 3 is an enlarged cross sectional view of a jet pump portion in the embodiment in FIG. 1;

FIG. 4 is a schematic view of a fuel tank in which a conventional reservoir cup is assembled; and

FIG. 5 is a cross sectional view of an assist jet mechanism of the fuel tank in FIG. 4 along a line IV-IV.

### DESCRIPTION OF THE PREFERRED EMBODIMENTS

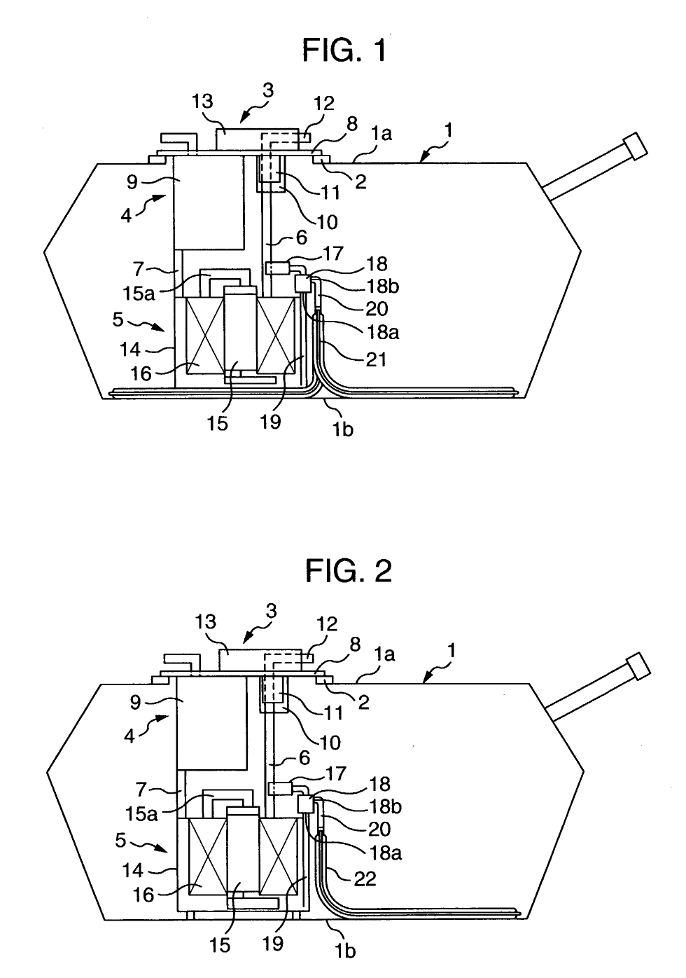

A description will be given of a desirable embodiment in accordance with the present invention with reference to the accompanying drawings. FIG. 1 is a conceptual view of a fuel supply apparatus in accordance with a first embodiment of the present invention. In FIG. 1, a fuel supply apparatus 3 is fixed to an upper surface 1a of a fuel tank 1 via a gasket 2. The fuel supply apparatus 3 is constituted of a set plate subassembly 4 and a pump subassembly 5, and both elements are connected to a fuel pipe 6, a power circuit (not shown) and a plurality of supporting members 7. The supporting member 7 is elastically constructed of an elastic member (not shown), and presses the pump subassembly 5 to a bottom surface 1b of the fuel tank 1. Both of the fuel pipe 6 and the power circuit (not shown) are constructed bendable.

A canister 9, a cut-off valve 10, a power connector 11, a main port 12 and a connector portion 13 are integrally formed in the set plate 8 constructing the set plate subassembly 4. The set plate 8 is fixed to the upper surface 1a of the fuel tank 1 via the gasket 2 by a fastening member (not shown). An evaporated fuel within the fuel tank 1 is introduced into the canister 9 from the cut-off valve 10 via a passage (not shown) provided within the connector portion 13, and is adsorbed to an adsorbent (not shown) received within the canister 9 so as to prevent it from leaking into an atmospheric air.

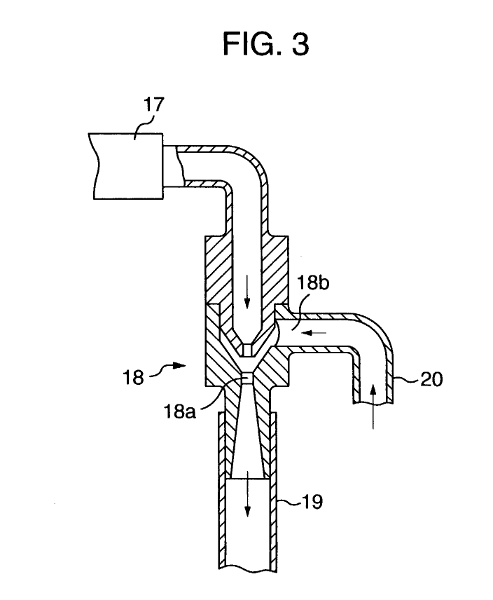

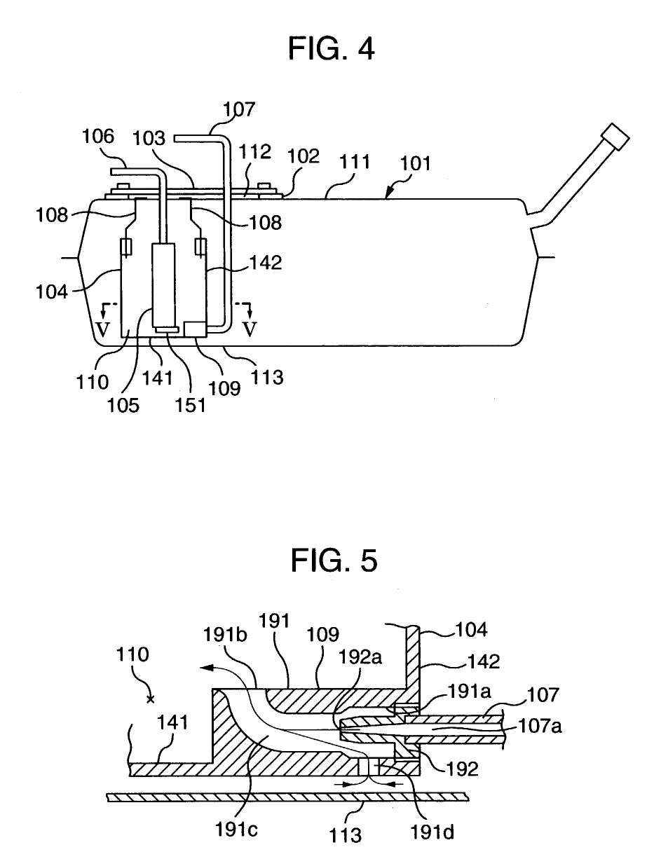

A fuel pump 15 is integrally provided within a reservoir cup 14 constituting the pump subassembly 5, and a high pressure filter 16 is integrally provided hermetically in the periphery of the fuel pump 15. The fuel pump 15 is communicated with an inlet of the high pressure filter 16 via a conduit 15a, and the fuel pipe 6 is introduced out to an outlet of the high pressure filter 16. The fuel pipe 6 is communicated with an engine (not shown) via the main port 12. A pressure regulator 17 in addition to the fuel pipe 6 is attached to the outlet of the high pressure filter 16, and a jet pump 18 is attached at a downstream side of the pressure regulator 17. As shown in FIG. 3, a discharge pipe 19 is attached to a discharge port 18a of the jet pump 18, and the discharge pipe 19 is open to an inner side of the reservoir cup 18. A suction pipe 20 is provided in a suction port 18b of the jet pipe 18, and a filter 21 is attached to a leading end of the suction pipe 20.

The filter 21 is formed in a vertically elongated bag shape by a cloth formed by a twill weave, a reserve dutch or the like, or a so-called mesh woven fabric which fibers are woven by an overlapped thread. The filter 21 is structured such as to be branched into two sections like a fork so as to extend to right and left ends in FIG. 1 of the bottom surface 1b along the bottom surface 1b of the fuel tank 1. In this case, since the filter can be extended in any direction of right and left ends or front and rear ends in the drawing in correspondence to a direction in which a vehicle tends to frequently incline, it is possible to select a suitable direction of the filter's extension accordingly. Further, in the case that the fuel supply apparatus 3 is attached so as to be slanted extremely in one direction of the fuel tank 1, as shown in a second embodiment in FIG. 2, the structure may be formed such that one filter 22 extends up to one of the right and left ends of the bottom surface 1b of the fuel tank 1. In this case, the same effect can be achieved. Incidentally, in this embodiment, the same numbers as these in the first embodiment are applied to the same members as these of the first embodiment, and the explanation of the members is omitted.

In this case, in the present embodiment, the description was given of the structure in which the jet pump is provided, however, the present invention can be applied to the structure in which an assist jet mechanism is provided.

Since the present invention is structured as mentioned above, the following effects can be achieved. That is, since the filter formed by the mesh woven fabric is provided in the suction port of the jet pump via the suction pipe, and at least a part of the filter extends up to at least one end portion along the bottom surface of the fuel tank, a drawing performance of drawing the fuel into the reservoir cup obtained by the jet pump does not come down, and the fuel supply to the engine is not short, even in the case that the fuel residual amount is small and the vehicle is inclined.

What is claimed is:

1. A fuel supply apparatus comprising:
a reservoir cup placed within a fuel tank;
a fuel pump provided within said reservoir cup and supplying a fuel within said reservoir cup to an engine; and
a jet pump for pressure feeding the fuel within said fuel tank into said reservoir cup by utilizing a flow speed of the returning fuel in the fuel supplied from said fuel pump,
wherein a filter is provided in a suction port of said jet pump via a suction pipe, said filter is constituted of a mesh woven fabric, and at least a part of said filter extends at least to one end portion along a bottom surface of said fuel tank.

2. A fuel supply apparatus according to claim 1, wherein said filter is branched into two sections, and said sections extend to opposite end portions on the bottom surface of the fuel tank.

3. A fuel supply apparatus according to claim 1, wherein said filter extends to one end portion on the bottom surface of the fuel tank.
